(19) United States
(12) Patent Application Publication
(10) Pub. No.: US 2009/0152187 A1
(43) Pub. Date: Jun. 18, 2009

(54) FILTER CHIP AND METHOD OF MANUFACTURING THE SAME

(75) Inventors: Dong Ho SHIN, Daejeon (KR); Young Jun KIM, Daejeon (KR); Min Suk JEONG, Cheollabook-do (KR); Sang Hee KIM, Daejeon (KR); Hye Yoon KIM, Daejeon (KR); Moon Youn JUNG, Daejeon (KR); Seon Hee PARK, Daejeon (KR)

Correspondence Address: AMPACC LAW GROUP, 13024 Beverly Park Road, Suite 205, Mukilteo, WA, 98275, US

(73) Assignee: Electronics and Telecommunications Research Institute, Daejeon (KR)

(21) Appl. No.: 12/142,701

(22) Filed: Jun. 19, 2008

(30) Foreign Application Priority Data
Dec. 17, 2007 (KR) 10-2007-132320

(51) Int. Cl. B01D 35/30; B23P 11/00

(52) U.S. Cl. 210/232; 29/428

(57) ABSTRACT

There are provided a filter chip in which a filter is mounted on a microfluidic device as a hybrid form, and a method of manufacturing the filter chip. The method includes: forming a bottom structure where a groove for stably mounting a filter is formed; mounting the filter on the groove; forming a top structure forming a fluid inlet for injecting a fluid into the filter; and covering the top structure on a top area of the groove to attach to the bottom structure, wherein the groove and the filter have a shape becoming narrow from the fluid inlet to a fluid outlet in such a way that the fluid receives a rapid change of a capillary force while passing through the filter. Accordingly, blood plasma is capable of being separated at a higher speed by increasing the capillary force of the fluid outlet, thereby obtaining the blood plasma as large amount as possible.

### CROSS-REFERENCE TO RELATED APPLICATIONS

This application claims the priority of Korean Patent Application No. 2007-0132320 filed on Dec. 17, 2007, in the Korean Intellectual Property Office, the disclosure of which is incorporated herein by reference.

### BACKGROUND OF THE INVENTION

1. Field of the Invention

The present invention relates to a filter chip and a method of manufacturing the same, and more particularly, to a filter chip where a filter is mounted on a microfluidic device as a hybrid form to separate blood plasma at high speed and a method of manufacturing the filter chip.

The present invention was supported by the IT R&D program of MIC/IITA [2006-S-007-02, Ubiquitous Health Monitoring Module and System Development].

2. Description of the Related Art

Recently, to allow a instant medical treatment at the spot, next-generation medical information technology capable of registering and inquiring clinical information such as medical treatment records, prescriptions, checkup results, and medication records, in real time. As such technology, there is a point of care (POC) diagnosis technology that is one of mobile radio frequency identification (RFID) service models. This is one of medical treatment information system to fully execute a basic object of quickly performing a medical treatment on a patient, instead of replacing a medical treatment system in a desktop environment, mutually complementary and having organic relationship.

The POC diagnosis technology diagnoses by using a biological sample such as blood or urine. In this case, since cells and particles included in the biological sample obstruct a flow of a fluid in a determination device, it becomes difficult to measure a material whose concentration is desired to know, in the biological fluid.

For example, red blood cells in blood may obstacle measurement by a spectroscope. Also, when a hematocrit is different, a volume of plasma in a given volume of a liquid of the blood becomes different. To overcome this problem, it is required to separate red blood cells from plasma to obtain a more define and uniform sample.

For example, urine includes lymphocytes that may have an effect on the measurement by the spectroscope and a flow in a filter and a capillary. Accordingly, a device for filtering cells, particles, or debris from the biological sample may improve quality of an analysis process with respect to the sample.

Filters used in the POC diagnosis technology may be largely divided into filters having a sieve form and membrane filters. In the case of sieve filters, a hole size is controlled in such a way that particles whose size is smaller than the hole size are allowed to pass through the sieve filters and particles whose size is greater than the hole size. In the case of membrane filters, proceeding of particles having a certain volume, such as micro particles or blood cells, is delayed, thereby allowing liquid elements such as blood plasma to go out from membrane filters first.

Sieve filters are manufactured by a semiconductor process or microelectromechanical systems (MEMS) process and have an ability of processing a small amount of blood. However, in the case of sieve filters, when using whole blood, blood cells block micro holes formed in sieve filters. Accordingly, since it is required to dilute the whole blood to a certain degree of a buffer liquid, sieve filters have not been generally used in diagnosis chips till now.

Up to now, filters employed in diagnosis chips and analyzing systems are membrane filters formed of glass fibers or cellulose. Membrane filters are generally used in diagnosis chips having a strip form. Recently, a filter mounted on a microfluidic device as a hybrid form is sold as a product. A general filter chip having the hybrid form may be manufactured as shown in FIGS. 1A to 1E.

As shown in FIGS. 1A and 1C, a filter is formed in the shape of a trapezoid. The general filter chip includes a groove 10 formed on a bottom structure 11, a filter 13 mounted on the groove 10, and a top structure 12 covering the filter 13. The filter chip further includes a fluid inlet 14 and a fluid outlet 15.

When forming the filter chip in a trapezoid shape, as shown in FIG. 1E, a capillary force becomes greater according to a flow direction of a fluid and a change rate of the capillary force becomes smaller. When injecting whole blood into the filter chip, due to basic material properties of a material of the filter 13, blood cells and blood plasma are separated from each other. While blood passes through the filter 13, the blood plasma becomes ahead of the blood cells and a distance between the blood cells and blood plasma becomes greater as closer to an end portion 20 of the filter 13. When once the blood cells are separated from the blood plasma and a boundary occurs therebetween, the blood cells do not easily get into the blood plasma. Such characteristics may be an advantage of the membrane filter. When the blood cells are separated from the blood plasma, the blood plasma should quickly thread through and flow into a connected fluidic device.

However, the blood plasma moving ahead of the blood cells do not easily proceed since receiving a kind of fluid resistance caused by the filter material. Accordingly, the blood plasma is accumulated in the filter for a certain amount of time and a separation time is delayed for the certain amount of time. This may be improved by hydrophilic processing the filter from a point where the blood cells are separated from the blood plasma to an end of the filter. There is a limitation to improving a velocity of the blood plasma by increasing a capillary force by processing a surface of the filter, actual effect of which is insignificant.

As another method, there is a method of increasing a capillary force by applying a pressure to the end portion 20 of the filter. Using this method, a velocity of a fluid flowing into the filter may be controlled and the blood plasma may be more quickly transferred to the fluidic device due to a strong capillary force when arriving at the end portion 20 of the filter. However, in this case, when more strongly applying a pressure to the end portion 20 of the filter, the filter itself may be blocked. Also, since the pressure is applied to only a small portion of the end portion 20 of the filter, there is no additional effect on the velocity of the fluid until the blood plasma arrives at the end portion 20. Also, the pressure is applied by junction between the top structure 12 and the bottom structure 11. In this case, a pressure change varies with a design of the bottom structure 11. Generally, since a thickness of the filter material is about 500 μm, a range of controlling the pressure is limited to the thickness of the filter.

### SUMMARY OF THE INVENTION

Recently, there is required a diagnosis chip capable of quickly and accurately diagnosing. For this, all process after blood-gathering and injecting blood into a diagnosis chip should be automated and performed for a short time. Considering this, time for separating blood plasma from whole blood may be very important. Also, it may be important to obtain an enough amount of the blood plasma from the injected blood.

To solve the problems and to satisfy technical requirements, an aspect of the present invention provides a filter chip and a method of manufacturing the filter chip, in which a physical shape of a filter mounted on a microfluidic device as a hybrid form is controlled to increase a capillary force of a fluid outlet portion, thereby more quickly separating blood plasma to obtain the blood plasma as large amount as possible.

According to an aspect of the present invention, there is provided a filter chip including: a filter; a bottom structure where a groove for stably mounting the filter is formed; a top structure covering a top area of the bottom structure; a fluid inlet formed in an area of the top structure to inject a fluid; and a fluid outlet in which a side surface of the bottom structure, opposite to the fluid inlet, is formed lower than an opposite side thereof, to discharge the fluid, wherein the groove and the filter have a shape becoming narrow from the fluid inlet to the fluid outlet in such a way that the fluid receives a rapid changed of a capillary force while passing through the filter.

According to another aspect of the present invention, there is provided a method of manufacturing a filter chip, the method including: forming a bottom structure where a groove for stably mounting a filter is formed; mounting the filter on the groove; forming a top structure forming a fluid inlet for injecting a fluid into the filter; and covering the top structure on a top area of the groove to attach to the bottom structure, wherein the groove and the filter have a shape becoming narrow from the fluid inlet to a fluid outlet in such a way that the fluid receives a rapid change of a capillary force while passing through the filter.

Accordingly, according to an exemplary embodiment of the present invention, there is provided a filter chip having a shape becoming narrower from a fluid inlet to a fluid outlet, the filter chip capable of more quickly separating blood plasma by increasing a capillary force at the fluid outlet, thereby obtaining the blood plasma as large amount as possible. Also, the filter chip may be useful for a diagnosis chip or an analyzing system requiring a process of removing blood cells and micro particles obstructing diagnosis or analysis.

### BRIEF DESCRIPTION OF THE DRAWINGS

The above and other aspects, features and other advantages of the present invention will be more clearly understood from the following detailed description taken in conjunction with the accompanying drawings, in which:

FIGS. 1A to 1E illustrate a configuration of a general filter chip and a change of a capillary force thereof;

FIGS. 2A to 2E illustrate a configuration of a filter chip according to an exemplary embodiment of the present invention;

FIG. 3 is a graph illustrating a change of a capillary force according to a proceeding direction of a fluid in the filter chip according to an exemplary embodiment of the present invention; and

FIGS. 4A to 4F illustrate examples of a filter of the filter chip according to an exemplary embodiment of the present invention.

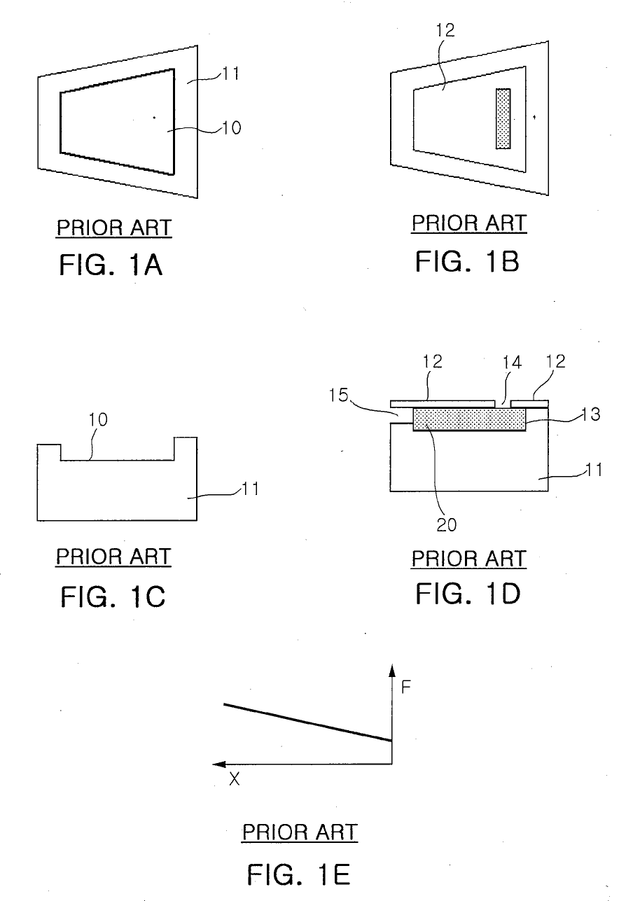

### DETAILED DESCRIPTION OF THE PREFERRED EMBODIMENT

Exemplary embodiments of the present invention will now be described in detail with reference to the accompanying drawings. Only, in describing operations of the exemplary embodiments in detail, when it is considered that a detailed description on related well-known functions or constitutions unnecessarily may make essential points of the present invention be unclear, the detailed description will be omitted.

In the present embodiment, a membrane filter having a structure in which a filter is mounted on a microfluidic device as a hybrid form will be described as an example. The membrane filter employs a shape in which a width becomes narrower toward an outlet of the filter in such a way that a fluid receives a greater capillary force as passing through the filter.

A configuration of the filter chip according to an exemplary embodiment of the present invention will be described with reference to the attached drawings.

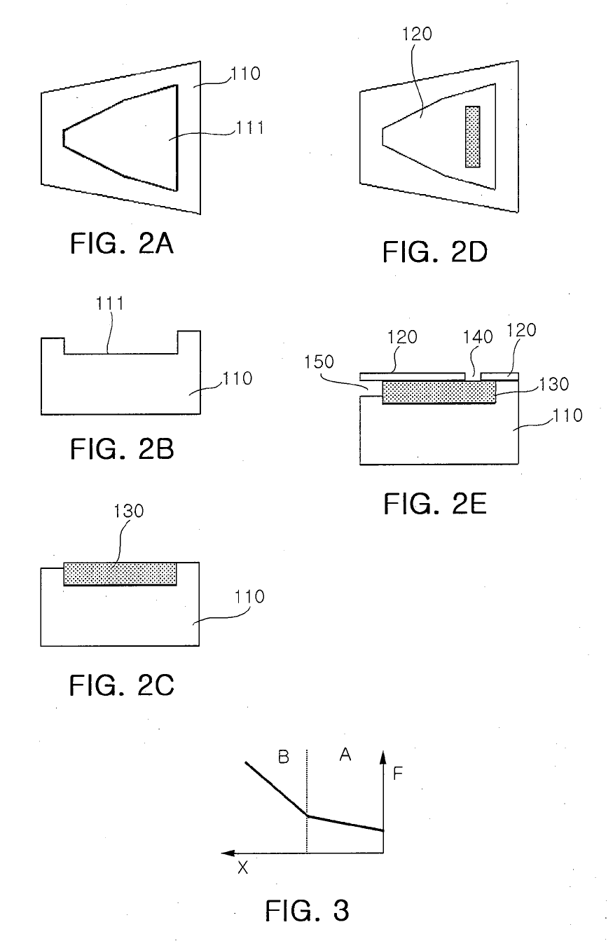

FIGS. 2A to 2E illustrate the configuration of the filter chip according to an exemplary embodiment of the present invention. FIG. 2A is a top view illustrating a bottom structure 110. FIG. 2B is a cross-section view of the bottom structure 110. FIG. 2C is a cross-sectional view illustrating a membrane filter 130 coupled with the bottom structure 110. FIG. 2D is a top view illustrating a top structure 120 coupled with the bottom structure 110. FIG. 2E is a cross-sectional view illustrating the top structure 120 coupled with the bottom structure 110.

Referring to FIGS. 2A to 2E, the filter chip may include the bottom structure 110, the top structure 120, and the membrane filter 130.

On the bottom structure 110, a groove 111 for mounting the membrane filter 130 is formed. Accordingly, the filter chip may be manufactured by mounting the membrane filter 130 on the bottom structure 110 and covering the bottom structure 110 with the top structure 120 to couple the top structure 120 with the bottom structure 110. To couple the top structure 120 with the bottom structure 110, ultrasonic welding or laser welding may be used.

The filter chip further includes a fluid inlet 140 and a fluid outlet 150. The fluid outlet 150 is connected to a microfluidic device in a hybrid form.

The membrane filter 130 may be formed of a porous material having three-dimensional spaces mutually connected. The porous material, due to a capillary effect, from a portion to supply a sample to the outlet, separates blood cells from blood plasma. The membrane filter 130 may be formed of nonwoven fabric formed of materials such as glass fibers, cellulose, pulp, and filter paper, in addition to the porous material.

In detail, as shown in FIGS. 2A and 2B, the groove 111 is formed on the bottom structure 110. As shown in FIGS. 2C and 2D, the membrane filter 130 is stably mounted on the groove 111. As shown in FIG. 2E, the top structure 120 is put thereon. In this case, the top structure 120 is put on to form the fluid inlet 140 and the fluid outlet 150, as shown in FIG. 2E.

When injecting blood into the membrane filter 130 via the fluid inlet 140, blood cells are separated from blood plasma at a point of ⅔ of an overall length of the membrane filter 130. When inducing a capillary force from this point to an end portion of the membrane filter 130, the separated blood plasma may be transferred at higher speed. As shown in FIG. 3, a discontinuous change of the capillary force at a point of ½ of the length of the membrane filter 130 may increase performance of the membrane filter 130 as high as possible. After the blood cells are separated from the blood plasma due to material properties of the membrane filter 130, the blood plasma receives a strong capillary force and may pass through the membrane filter 130 at higher speed.

On the other hand, surfaces of the top and bottom structures 120 and 110, where the membrane filter 130 is mounted, may have great hydrophilic properties. According to a degree of the hydrophilic properties of the top and bottom structures 120 and 110, there is a difference in separation speed. When there is a contact angle of 30 degrees between a hydrophobic surface and a hydrophilic surface, a difference of speed of separating the blood cells from the blood plasma may be 10 times.

The membrane filter chip 130, as shown in FIGS. 2A and 2D, is manufactured in such a way that a width of the membrane filter 130 becomes rapidly narrower from a point of ½ of the overall length of the membrane filter 130. That is, the groove 111 and the membrane filter 130 are formed in a shape becoming narrower from the fluid inlet 140 to the fluid outlet 150 in such a way that the fluid receives a rapid change of the capillary force while passing through the membrane filter 130. In this case, the top structure 120 is formed in a shape like the above and is put on the groove ill to couple with the bottom structure 110.

When injecting a fluid into the membrane filter 130 formed as described above, the injected fluid, as shown in FIG. 3, does not receive a great change of a capillary force until passing through A area. However, when out of the A area and entering B area, the fluid passes through a rapid change of the capillary force. Accordingly, when injecting whole blood into the filter inlet 140, blood cells are separated from blood plasma while passing through the A area. The separated blood plasma precedes the blood cells and arrives at an end portion of the A area. Also, entering the B area, the blood plasma passes through the rapid change of the capillary force. Accordingly, since the separated blood plasma does not accumulated in a certain section, the blood plasma is out of the membrane filter 130 and flows into a fluidic device at very high speed.

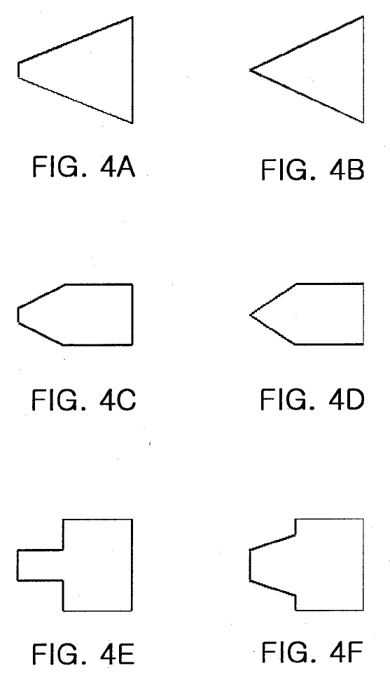

On the other hand, according to an amount of blood and material properties of a filter, a phase of separating blood cells from blood plasma may be different. Accordingly, it is required to change a shape of a filter. The filter chip according to an exemplary embodiment of the present invention may have various shapes capable of inducing a rapid capillary force, as shown in FIGS. 4A to 4F, in addition to the shape of the filter chip shown in FIGS. 2A to 2E.

While the present invention has been shown and described in connection with the exemplary embodiments, it will be apparent to those skilled in the art that modifications and variations can be made without departing from the spirit and scope of the invention as defined by the appended claims.

What is claimed is:

1. A filter chip comprising:
a filter;
a bottom structure where a groove for stably mounting the filter is formed;
a top structure covering a top area of the bottom structure;
a fluid inlet formed in an area of the top structure to inject a fluid; and
a fluid outlet in which a side surface of the bottom structure, opposite to the fluid inlet, is formed lower than an opposite side thereof, to discharge the fluid,
wherein the groove and the filter have a shape becoming narrow from the fluid inlet to the fluid outlet in such a way that the fluid receives a rapid changed of a capillary force while passing through the filter.

2. The filter chip of claim 1, wherein the filter has the capillary force increasing from the fluid inlet to the fluid outlet and separates blood corpuscles and blood plasmas from injected whole blood through a certain area.

3. The filter chip of claim 2, wherein the filter is a membrane filter formed of one of glass fibers, cellulose, pulp, filter paper, and a porous material.

4. A method of manufacturing a filter chip, the method comprising:
forming a bottom structure where a groove for stably mounting a filter is formed;
mounting the filter on the groove;
forming a top structure forming a fluid inlet for injecting a fluid into the filter; and
covering the top structure on a top area of the groove to attach to the bottom structure,
wherein the groove and the filter have a shape becoming narrow from the fluid inlet to a fluid outlet in such a way that the fluid receives a rapid change of a capillary force while passing through the filter.

5. The method of claim 4, wherein the filter has the capillary force increasing from the fluid inlet to the fluid outlet and separates blood corpuscles and blood plasma from injected whole blood through a certain area.

6. The method of claim 5, wherein the filter is a membrane filter formed of one of glass fibers, cellulose, pulp, filter paper, and a porous material.
